(19) United States
(12) Patent Application Publication
(10) Pub. No.: US 2025/0235896 A1
(43) Pub. Date: Jul. 24, 2025

(54) PNEUMATIC CLASSIFIER

(71) Applicants: NISSHIN SEIFUN GROUP INC., Tokyo (JP); NISSHIN ENGINEERING INC., Tokyo (JP)

(72) Inventors: Kenji JIKIHARA, Fujimino-city (JP); Takumi KOMINE, Fujimino-city (JP)

(21) Appl. No.: 18/701,046

(22) PCT Filed: Oct. 4, 2022
(86) PCT No.: PCT/JP2022/037146

§ 371 Date: Apr. 12, 2024

(30) Foreign Application Priority Data
Oct. 14, 2021 (JP) 2021-168644

(51) Int. Cl. B07B 7/08; B07B 11/06

(52) U.S. Cl. CPC B07B 7/08; B07B 11/06

(57) ABSTRACT

A pneumatic classifier includes: a casing having a ceiling wall and an annular wall; a classifying plate disposed such that a surface of the classifying plate faces the ceiling wall; a classifying chamber constituted between the ceiling wall and the surface of the classifying plate; a gas supply section configured to supply gas into the classifying chamber to generate a whirling stream; a feed powder supply section configured to supply feed powder to the whirling stream; a fine powder discharging port provided at a central part of one of the ceiling wall of the casing and the surface of the classifying plate; a coarse powder discharging port opening along an outer periphery of the classifying chamber on a side of the ceiling wall or the surface of the classifying chamber; and a groove portion provided in at least one of the ceiling wall or the surface of the classifying plate.

### TECHNICAL FIELD

The present invention relates to a pneumatic classifier that classifies feed powder having a particle size distribution into fine powder and coarse powder according to a desired particle size (classification point) using a balance between a centrifugal force imparted to the powder through a whirling stream formed from gas and a drag, particularly to a pneumatic classifier that achieves a smaller classification point while maintaining classification accuracy.

### BACKGROUND ART

At present, fine particles such as oxide fine particles, nitride fine particles and carbide fine particles are used in the production of semiconductor substrates, printed circuit boards, electrical insulation materials for various electrical insulation parts and the like, cutting tools, dies, bearings and other high-hardness and high-precision machining tool materials, functional materials for humidity sensors and the like, and sintered bodies for use as precision sinter molding materials, and in the production of thermal sprayed parts such as engine valves made of materials that are required to be wear-resistant at a high temperature, as well as in the fields of electrode or electrolyte materials and various catalysts for fuel cells. The use of those fine particles improves bonding strength between different ceramics or different metals and denseness as well as functionalities of sintered bodies, thermal sprayed parts and the like.

The above-described fine particles are produced by a chemical approach in which various gases or the like are chemically reacted at high temperature or a physical approach in which substances are irradiated with an electron beam, laser beam or the like to be decomposed and vaporized, thereby generating fine particles. The fine particles produced by the above approaches have a particle size distribution and contain coarse powder and fine powder mixed together. The fine particles used in the applications described above preferably have a smaller proportion of coarse powder, since excellent properties can be achieved. Also for metallic fine particles, a smaller proportion of coarse powder is preferred because this leads to excellent properties.

Accordingly, for example, pneumatic classifiers, powder classifying apparatuses and other apparatuses are used to provide a whirling motion to powder by means of a whirling stream, thereby centrifuging powder into coarse powder and fine powder.

For instance, Patent Literature 1 describes a powder classifying apparatus in which powder having a particle size distribution is carried by an air stream and supplied. The powder classifying apparatus of Patent Literature 1 includes: a hollow cavity in a disc-like shape (disc-like cavity portion) in which the supplied powder having a particle size distribution is classified; a powder supply port for supplying the powder having a particle size distribution to the disc-like cavity portion; a plurality of guide vanes arranged so as to each extend from an outer circumference of the disc-like cavity portion in an inward direction at a given angle; a discharge unit for an air stream including fine powder discharged from the disc-like cavity portion; a collection unit for coarse powder discharged from the disc-like cavity portion; and a plurality of air nozzles arranged on an outer circumferential wall of the disc-like cavity portion along a tangential direction of the outer circumferential wall below the guide vanes and blowing compressed air toward the collection unit for coarse powder inside the disc-like cavity portion to bring fine powder present near the collection unit for coarse powder back to the disc-like cavity portion.

Patent Literature 2 describes a classifying apparatus. In the apparatus, powder supplied from a supply port formed in the upper part of an apparatus body is guided downward while being swirled in the apparatus body; there is provided a suction pipe that is constituted of a multilayer pipe, that has a suction port at its upper end, and that is disported in the central part of the apparatus body; and small particle size powder in the powder guided downward while being swirled is sucked from the suction port through the suction pipe.

In the Patent Literature 2, particles having different particle sizes are separately sucked and collected through the suction pipe constituted of a multilayer pipe.

### CITATION LIST

### Patent Literature

PATENT LITERATURE 1: JP 4785802 B
PATENT LITERATURE 2: JP 2000-107698 A

### SUMMARY OF INVENTION

### Technical Problems

While the powder classifying apparatus of Patent Literature 1 can classify feed powder having a particle size distribution into fine powder and coarse powder at a desired particle size (classification point), the demanded particle size of fine powder becomes smaller recently, and it is desirable that the classification point of a powder classifying apparatus is further small.

In Patent Literature 2, one unit of feed powder is classified in one classifying operation, and particles having different particle sizes are separately collected through the foregoing suction pipe constituted of a multilayer pipe, i.e., through respective pipes composing the multilayer pipe.

Thus, in Patent Literature 2, powder can be separately collected through the respective pipes composing the multilayer pipe, and this configuration reduces the variation in size of powder collected through each pipe; however, a classification point is determined by the air volume balance among the respective suction pipes, and this does not lead to a smaller classification point.

In addition, it is desirable that when powder is classified, the classification can be performed stably for a long period of time, and classification accuracy can be maintained.

An object of the present invention is to solve the problems inherent in the prior art and to provide a pneumatic classifier that achieves a smaller classification point while maintaining classification accuracy for a long period of time.

### Solution to Problems

In order to attain the above-mentioned object, an embodiment of the present invention provides a pneumatic classifier comprising: a casing having a ceiling wall and an annular wall provided continuously to an outer edge of the ceiling wall; a classifying plate disposed such that a surface of the classifying plate faces the ceiling wall of the casing; a classifying chamber constituted between the ceiling wall of the casing and the surface of the classifying plate; a gas supply section configured to supply gas into the classifying chamber to generate a whirling stream; a feed powder supply section configured to supply feed powder to the whirling stream generated in the classifying chamber; a fine powder discharging port provided at a central part of one of the ceiling wall of the casing and the surface of the classifying plate that constitute the classifying chamber; a coarse powder discharging port opening along an outer periphery of the classifying chamber on a side of either the ceiling wall or the surface of the classifying chamber that faces the ceiling wall; and a groove portion provided in at least one of the ceiling wall or the surface of the classifying plate.

It is preferable that the pneumatic classifier includes at least one of a first cylindrical portion provided at the fine powder discharging port or a second cylindrical portion provided in the surface of the classifying plate of the classifying chamber to face the first cylindrical portion at a predetermined distance.

It is preferable that a diameter of the first cylindrical portion is different from that of the second cylindrical portion.

It is preferable that an inclined surface is formed in at least one of the ceiling wall of the casing or the surface of the classifying plate and that the groove portion is provided in the inclined surface.

It is preferable that an inclined surface is formed in at least one of a peripheral edge of the first cylindrical portion of the ceiling wall of the casing or a peripheral edge of the second cylindrical portion of the surface of the classifying plate and that the groove portion is provided in the inclined surface.

It is preferable that the fine powder discharging port has a circular shape, and the groove portion is arranged concentrically with the fine powder discharging port.

It is preferable that the groove portion is provided in each of the ceiling wall and the surface of the classifying plate.

It is preferable that the fine powder discharging port has a circular shape, the groove portion is arranged concentrically with the fine powder discharging port, and the groove portion provided in the ceiling wall faces the groove portion provided in the surface of the classifying plate.

It is preferable that in one of the ceiling wall and the surface of the classifying plate, the one having the fine powder discharging port, the groove portion is provided concentrically with the fine powder discharging port along a periphery of the fine powder discharging port, and in another of the ceiling wall and the surface of the classifying plate, the another having no fine powder discharging port, a groove portion of concentric circle shape is provided to face the groove portion of the concentric circle shape provided in a region around the fine powder discharging port and that the groove portion of the concentric circle shape provided in the one having the fine powder discharging port and the groove portion of the concentric circle shape provided in the another having no fine powder discharging port are disposed at a same position in a direction perpendicular to a direction in which the ceiling wall of the casing of the classifying chamber and the surface of the classifying plate face each other.

It is preferable that a plurality of the groove portions are provided along a periphery of the fine powder discharging port.

It is preferable that the first cylindrical portion is provided in the ceiling wall and that the groove portion is provided in the surface of the classifying plate.

It is preferable that the second cylindrical portion is provided in the surface of the classifying plate, and the groove portion is provided in the ceiling wall.

It is preferable that the inclined surface is inclined such that a height of the classifying chamber is gradually increased from an outer side to a center of the classifying chamber.

It is preferable that the inclined surface is inclined such that a height of the classifying chamber is decreased from an outer side to a center of the classifying chamber.

It is preferable that the feed powder supply section is connected to one of the ceiling wall of the casing and the surface of the classifying plate that constitute the classifying chamber and supplies the feed powder to the swirling stream generated in the classifying chamber.

It is preferable that the feed powder supply section includes an ejection nozzle that supplies the feed powder to the swirling stream generated in the classifying chamber.

It is preferable that the gas supply section includes a plurality of air nozzles, and the plurality of air nozzles are arranged at regular intervals in a circumferential direction of the classifying chamber along an outer edge of the classifying chamber.

It is preferable that the gas supply section includes a plurality of guide vanes, and the plurality of guide vanes are arranged at regular intervals in a circumferential direction of the classifying chamber along an outer edge of the classifying chamber.

### Advantageous Effects of Invention

According to the present invention, in classification of feed powder having a particle size distribution into fine powder and coarse powder, a classification point can be smaller than that in a conventional one while classification accuracy is maintained for a long period of time.

### BRIEF DESCRIPTION OF DRAWINGS

FIG. 1 is a schematic cross-sectional view showing a first example of a pneumatic classifier in an embodiment of the invention.

FIG. 2 is a schematic view showing an example of a groove portion of the first example of the pneumatic classifier in the embodiment of the invention.

FIG. 3 is a schematic view showing another example of the groove portion of the first example of the pneumatic classifier in the embodiment of the invention.

FIG. 4 is a schematic cross-sectional view showing a second example of the pneumatic classifier in the embodiment of the invention.

FIG. 5 is a schematic partial cross-sectional view showing a third example of the pneumatic classifier in the embodiment of the invention.

FIG. 6 is a schematic partial cross-sectional view showing a fourth example of the pneumatic classifier in the embodiment of the invention.

FIG. 7 is a schematic partial cross-sectional view showing a fifth example of the pneumatic classifier in the embodiment of the invention.

FIG. 8 is a schematic partial cross-sectional view showing a sixth example of the pneumatic classifier in the embodiment of the invention.

FIG. 9 is a schematic partial cross-sectional view showing a seventh example of the pneumatic classifier in the embodiment of the invention.

FIG. 10 is a schematic partial cross-sectional view showing an eighth example of the pneumatic classifier in the embodiment of the invention.

FIG. 11 is a schematic partial cross-sectional view showing a ninth example of the pneumatic classifier in the embodiment of the invention.

FIG. 12 is a schematic partial cross-sectional view showing a tenth example of the pneumatic classifier in the embodiment of the invention.

FIG. 13 is a schematic cross-sectional view showing an eleventh example of the pneumatic classifier in the embodiment of the invention.

FIG. 14 is a schematic cross-sectional view showing a first pneumatic classifier for comparison.

FIG. 15 is a graph showing a result of classification.

FIG. 16 is a schematic view showing ceramic particles after classification by means of the pneumatic classifier of the invention.

FIG. 17 is a schematic view showing ceramic particles after classification by means of the first pneumatic classifier for comparison.

FIG. 18 is a schematic partial cross-sectional view showing a second pneumatic classifier for comparison.

FIG. 19 is a graph showing a result of classification.

FIG. 20 is a schematic view showing ceramic particles after classification by means of the pneumatic classifier of the invention.

FIG. 21 is a schematic view showing ceramic particles after classification by means of the second pneumatic classifier for comparison.

### DESCRIPTION OF EMBODIMENTS

On the following pages, a pneumatic classifier of the present invention is described in detail with reference to a preferred embodiment shown in the accompanying drawings.

Drawings to be described below are illustrative to describe the invention, and the invention is not limited to the drawings to be described below.

### (First Example of Pneumatic Classifier)

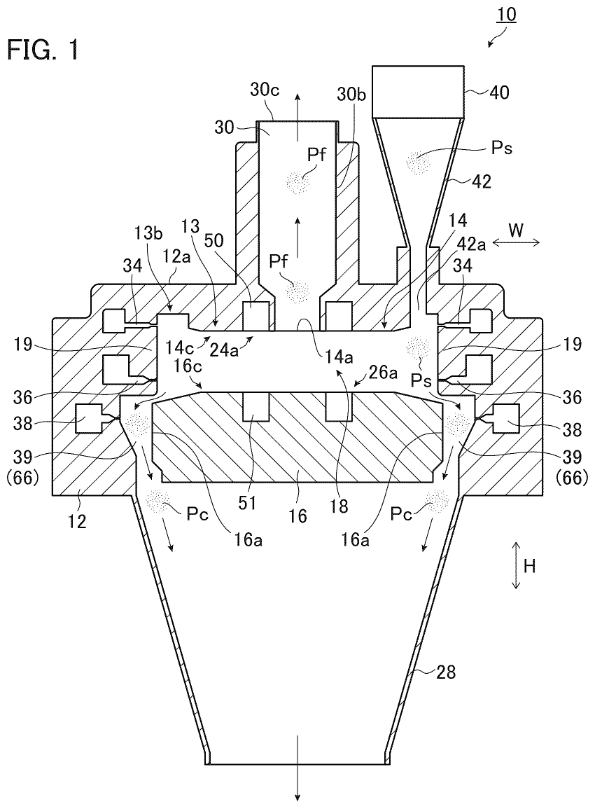

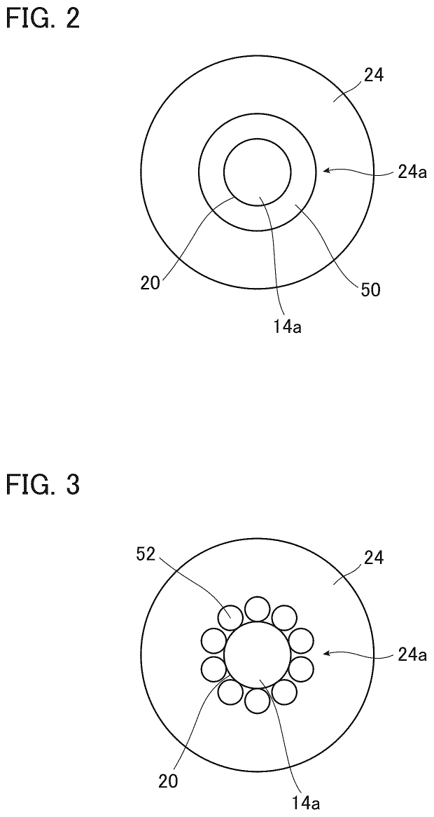

FIG. 1 is a schematic cross-sectional view showing a first example of a pneumatic classifier in an embodiment of the invention, FIG. 2 is a schematic view showing an example of a groove portion of the first example of the pneumatic classifier in the embodiment of the invention, and FIG. 3 is a schematic view showing another example of the groove portion of the first example of the pneumatic classifier in the embodiment of the invention.

A pneumatic classifier 10 shown in FIG. 1 classifies feed powder having a particle size distribution into fine powder Pf and coarse powder Pc according to a desired particle size (classification point) using a balance between a centrifugal force imparted to the powder through a whirling stream formed from gas and a drag.

The pneumatic classifier 10 shown in FIG. 1 includes a cylindrical casing 12, for instance. The casing 12 includes a ceiling wall 13 and an annular wall 19 continuous with an outer edge 13b of the ceiling wall 13. The ceiling wall 13 constitutes an upper disc-shaped portion 14 of circular shape, and the casing 12 includes the upper disc-shaped portion 14. A classifying plate 16 is disposed such that a surface 16c thereof faces the ceiling wall 13 of the casing 12, i.e., the upper disc-shaped portion 14 at a predetermined distance. The classifying plate 16 has a substantially circular outline. The upper disc-shaped portion 14 (the ceiling wall 13) and the classifying plate 16 are disposed to face each other in a direction H.

A substantially disc-shaped classifying chamber 18 is defined between the upper disc-shaped portion 14 and the classifying plate 16, and the outer periphery of the classifying chamber 18 in the circumferential direction is closed by the annular wall 19 of the casing 12. Thus, the classifying chamber 18 is a space formed between the ceiling wall 13 (a surface 14c of the upper disk-shaped portion 14) and the surface 16c of the classifying plate 16 that face each other and is constituted between the ceiling wall 13 of the casing 12 and the surface 16c of the classifying plate 16. Thus, the upper disc-shaped portion 14 (the ceiling wall 13) and the classifying plate 16 are members forming the space of the classifying chamber 18. Feed powder having a particle size distribution is separated and classified into, for example, coarse powder and fine powder in the classifying chamber 18.

A fine powder discharging port 14a is provided in its central portion with the upper disc-shaped portion 14. The fine powder discharging port 14a communicates with the classifying chamber 18. The fine powder discharging port 14a has, for instance, a circular shape. The fine powder discharging port 14a is used to discharge fine powder of coarse powder and the fine powder generated by separating feed powder in the classifying chamber 18, which will be described later.

The surface 14c of the upper disc-shaped portion 14 that faces the classifying chamber 18 is constituted of, for instance, a flat surface parallel to a direction W. The direction W is perpendicular to the direction H.

The surface 16c of the classifying plate 16 that faces the classifying chamber 18 is constituted of, for instance, a flat surface parallel to the direction W. The surface 14c of the upper disc-shaped portion 14 and the surface 16c of the classifying plate 16 are parallel to each other.

In the upper disc-shaped portion 14, a groove portion 50 is provided in a first region 24a around the fine powder discharging port 14a. The groove portion 50 is provided to be recessed from the surface 14c of the upper disc-shaped portion 14.

For example, the groove portion 50 is arranged along and concentrically with the fine powder discharging port 14a as shown in FIG. 2. In the ceiling wall 13 (upper disc-shaped portion 14) that has the fine powder discharging port 14a, the groove portion 50 is provided along the periphery of the fine powder discharging port 14a and concentrically with the fine powder discharging port 14a.

In the classifying plate 16, a groove portion 51 is provided in a second region 26a that faces the first region 24a around the fine powder discharging port 14a. The groove portion 51 is provided to be recessed from the surface 16c of the classifying plate 16. In the member that has no opening portion (e.g, the classifying plate 16), the concentric groove portion 51 is provided to face the concentric groove portion 50 provided in the region around the fine powder discharging port 14a. The groove portion 51 has the same configuration as the groove portion 50.

The groove portion 50 of the upper disc-shaped portion 14 and the groove portion 51 of the classifying plate 16 are arranged to face each other in the direction H. For example, the concentric groove portion 50 provided in the upper disc-shaped portion 14 (one of the members) and the concentric groove portion 51 provided in the classifying plate 16 (the other of the member) are provided at the same position in the direction W perpendicular to the direction H in which the two members of the classifying chamber 18, i.e., the upper disc-shaped portion 14 and the classifying plate 16 face each other.

The groove portion 50 and the groove portion 51 both have a rectangular cross-sectional shape. The cross-sectional shape of each of the groove portion 50 and the groove portion 51 is not limited to a rectangular shape, and the bottom portion thereof may be a flat surface, a curved surface, or a bent surface. For example, the cross-sectional shape thereof may be a U shape or a V shape.

While the groove portion 51 and the groove portion 50 have the same configuration, and these grooves are the same in width in the direction W and depth in the direction H, the invention is not limited thereto. The groove portion 50 and the groove portion 51 may be different in width in the direction W or in depth in the direction H.

The groove portion 50 is not limited to being provided along the outer edge of the fine powder discharging port 14a as long as the position where the groove portion 50 is provided is within the first region 24a around the fine powder discharging port 14a.

As described above, the groove portions 50 and 51 are provided, for example, concentrically with the fine powder discharging port 14a as shown in FIG. 2, but the invention is not limited thereto. For example, as shown in FIG. 3, a configuration in which a plurality of groove portions 52 are provided along the periphery of the fine powder discharging port 14a may be applied. The opening portion of the groove portion 52 has, for instance, a circular shape.

The groove portion may be provided in at least one of the two opposed members forming the classifying chamber 18, i.e., the upper disc-shaped portion 14 and the classifying plate 16. In other words, it suffices if the groove portion is provided to be recessed in at least one of the first region 24a around the fine powder discharging port 14a and the second region 26a facing the first region 24a around the fine powder discharging port 14a.

In classification of powder, the provision of the groove portion suppresses adhesion of powder to the inside of the classifying chamber 18. When powder is adhered to the inside of the classifying chamber 18, the adhered powder may be flaked; however, probability of flaking of the powder can be lowered when the adhesion of the power is suppressed. Thus, powder can be stably classified for a long period of time, whereby classification accuracy can be maintained for a long period of time.

Further, a classification point can be small. In other words, powder can be classified into fine powder and coarse powder in terms of a smaller particle size. In addition, since the provision of the groove portion can suppress a speed of powder locally directed from the outside of the apparatus toward the fine powder discharging port 14a, a classification point can be small. Thus, powder can be classified into fine powder and coarse powder in terms of a smaller particle size.

While the groove portion 50 of the upper disc-shaped portion 14 and the groove portion 51 of the classifying plate 16 are provided as described above, the invention is not limited thereto, and it suffices if at least one of the groove portion 50 of the upper disc-shaped portion 14 and the groove portion 51 of the classifying plate 16 is provided.

A fine powder collecting pipe 30 is disposed at the fine particle discharging port 14a to project in a direction perpendicular to the surface 12a of the casing 12. This perpendicular direction is parallel to the direction H.

The fine powder collecting pipe 30 is used to discharge gas containing fine powder Pf separated through classification in the classifying chamber 18, to the outside of the classifying chamber 18 via a gap 23. An end 30c of the fine powder collecting pipe 30 on the opposite side from the classifying chamber 18 is joined to a suction blower (not shown) via, for example, a bag filter (not shown) and other components. The bag filter (not shown), the suction blower (not shown) and other components constitute a fine powder collecting device. The fine powder collecting pipe 30 constitutes a fine powder collecting section. Of coarse powder and fine powder generated by separating feed powder in the classifying chamber 18, the fine powder is discharged from the fine powder discharging port 14a of the upper disc-shaped portion 14.

A gap 39 is formed between an outer end portion 16a of the classifying plate 16 and the annular wall 19 of the casing 12. The gap 39 is situated at an outer edge portion of the classifying chamber 18. For instance, a coarse powder collecting chamber 28 of hollow truncated cone shape is disposed under the casing 12. The classifying chamber 18 and the coarse powder collecting chamber 28 communicate with each other by the gap 39. The outer edge portion of the classifying chamber 18 is larger in height in the direction H than the central portion thereof, and the outer edge portion of the classifying chamber 18 extends wider in the direction H.

The coarse powder collecting chamber 28 is used to discharge coarse powder Pc separated through classification in the classifying chamber 18, to the outside of the classifying chamber 18. The coarse powder collecting chamber 28 is provided with a coarse powder collecting pipe (not shown) for collecting separated coarse powder. The coarse powder collecting pipe is provided at its lower end with, for example, a hopper (not shown) via a rotary valve (not shown). The coarse powder Pc obtained by classifying the feed powder in the classifying chamber 18 is collected in the hopper via the gap 39, the coarse powder collecting chamber 28 and the coarse powder collecting pipe. The above-described gap 39 constitutes a coarse powder discharging port 66. The coarse powder discharging port 66 is used to discharge coarse powder of the coarse powder and fine powder generated by separating feed powder in the classifying chamber 18.

The coarse powder collecting chamber 28 constitutes a coarse powder collecting section. In the configuration of the coarse powder collecting section shown in FIG. 1, the fine powder Pf is discharged from the side of the upper disc-shaped portion 14 (one of the members), while the coarse powder Pc is discharged from the side of the classifying plate 16 (the other of the members) and also the gap 39 (the coarse powder discharging port 66) situated at the outer edge portion of the classifying chamber 18.

Here, the coarse powder collecting section, e.g., the coarse powder collecting chamber 28 is disposed, to communicate with the classifying chamber 18, on the side of either of the members, i.e., the upper disc-shaped portion 14 (one of the members) and the classifying plate 16 (the other of the members) that faces the upper disc-shaped portion 14 (one of the members) across the classifying chamber 18 and also at the outer edge portion of the classifying chamber 18, and is used to discharge the coarse powder Pc separated through classification in the classifying chamber 18. The configuration of the coarse powder collecting section is not limited to the configuration shown in FIG. 1.

A plurality of first air nozzles 34 are disposed in the annular wall 19 of the casing 12 on the fine powder collecting pipe 30 side in the H direction. In addition, second air nozzles 36 are also disposed in the annular wall 19 under the first air nozzles 34 in the H direction. In other words, the plurality of second air nozzles 36 are disposed.

Further, third air nozzles 38 are disposed in the cylindrical casing 12 under the second air nozzles 36 in the H direction. In other words, the plurality of third air nozzles are disposed.

Although not illustrated in detail, the plurality of first air nozzles 34 are disposed along the outer edge of the classifying chamber 18 and arranged at regular intervals in the circumferential direction of the classifying chamber 18 at a predetermined angle to a tangential direction of the outer edge of the classifying chamber 18. The number of the first air nozzles 34 is, for example, six.

As with the first air nozzles 34, the plurality of second air nozzles 36 and the plurality of third air nozzles 38 are disposed along the outer edge of the classifying chamber 18 and arranged at regular intervals in the circumferential direction of the classifying chamber 18 at a predetermined angle to the tangential direction of the outer edge of the classifying chamber 18. The number of each of the second air nozzles 36 and the third air nozzles 38 is, for example, six. A gas supply section includes the first air nozzles 34 and the second air nozzles 36. While the gas supply section includes the first air nozzles 34 and the second air nozzles 36, it may include either the first air nozzles 34 or the second air nozzles 36.

The first air nozzles 34, the second air nozzles 36, and the third air nozzles 38 are separately connected to pressurized gas supply sections (not shown) and each have a gas injecting port. Upon supply of gas under predetermined pressures from the pressurized gas supply sections to the first air nozzles 34 and the second air nozzles 36, pressurized gas is ejected from the first air nozzles 34 and the second air nozzles 36 separately, whereby whirling streams whirling in the same direction are formed in the classifying chamber 18. The type of gas is appropriately determined depending on the feed powder to be classified, the purpose or other factors, and one example of gas is air. When feed powder is reactive with air, another type of gas that is not reactive therewith is suitably used.

In addition, upon supply of gas under a predetermined pressure from the pressurized gas supply section to the third air nozzles 38, pressurized gas is ejected from the third air nozzles 38 and is supplied to the gap 39 between the outer end portion 16a of the classifying plate 16 and the casing 12.

The numbers of the first air nozzles 34, the second air nozzles 36, and the third air nozzles 38 disposed are not limited to the above-mentioned numbers, may be one or plural, and are appropriately determined depending on the apparatus configuration or other factors.

The second air nozzles 36 are not limited to nozzles, may be guide vanes or other components as described later, and appropriately determined depending on the apparatus configuration.

The casing 12 is provided on its surface 12a with a supply pipe 42 that is situated at a predetermined distance from the fine powder collecting pipe 30 in the direction W. The supply pipe 42 is disposed at the outer edge portion of the casing 12. For instance, the supply pipe 42 is provided at its top with a feed powder supply section 40 for supplying feed powder Ps into the classifying chamber 18. The supply pipe 42 has a hollow truncated cone shape, for instance. The supply pipe 42 is configured such that a small-diameter distal end of the truncated cone is disposed to face the surface 12a of the casing 12. A joint portion between the supply pipe 42 and the casing 12 is constituted of a pipe whose diameter is constant. The supply pipe 42 is connected to, for example, the upper disc-shaped portion 14, and the feed powder Ps passes through an opening portion 42a of the upper disc-shaped portion 14 and is supplied into the classifying chamber 18.

Next, the operation of the pneumatic classifier 10 is described.

First, air intake is performed by the suction blower (not shown) at a predetermined air volume from the classifying chamber 18 via the fine powder collecting pipe 30, and pressurized gas is supplied from the pressurized gas supply sections (not shown) to the first air nozzles 34 and the second air nozzles 36 to generate a whirling stream in the classifying chamber 18.

In this state, a predetermined amount of the feed powder Ps having a particle size distribution passes through the opening portion 42a of the upper disc-shaped portion 14 from the feed powder supply section 40 and is supplied to the whirling streams of the classifying chamber 18.

Since the whirling stream is formed in the classifying chamber 18 due to the ejection of the pressurized gas from the first air nozzles 34 and the second air nozzles 36, the feed powder Ps supplied from a feed powder ejecting nozzle (not shown) into the classifying chamber 18 is swirled in the classifying chamber 18 and receives a centrifugal separation effect in the classifying chamber 18. As a result, since the groove portion 50 and the groove portion 51 provided in the classifying chamber 18 can suppress a speed of the powder locally directed from the outside of the apparatus toward the fine powder discharging port 14a, the classification point is small. Thus, powder can be classified into fine powder and coarse powder in term of a smaller particle size. Therefore, the coarse powder Pc having a large particle size does not flow into the fine powder collecting pipe 30 via the fine powder discharging port 14a and remains in the classifying chamber 18, while the fine powder Pf having a size of the classification point or less is, together with an air stream, sucked, passed through the fine powder discharging port 14a, and discharged from the fine particle collecting pipe 30.

In this manner, the fine powder Pf can be separated through classification and collected from the feed powder Ps having a particle size distribution. Further, as described above, provision of the groove portion 50 and the groove portion 51 suppresses adhesion of powder to the inside of the classifying chamber 18. Since powder can be stably classified for a long period of time, classification accuracy can be maintained for a long period of time. The collected fine powder Pf can have a smaller particle size.

The remaining part of the feed powder that has not been discharged from the fine particle collecting pipe 30, i.e., the coarse powder Pc passes through the gap 39 between the classifying plate 16 and the annular wall 19 and falls from the classifying chamber 18 into the coarse powder collecting chamber 28. Thereafter, the remaining part of the feed powder, i.e., the coarse powder Pc is collected via a coarse powder collecting pipe (not shown).

Classification can be performed with high accuracy in a guide vane method rather than an air nozzle method depending on conditions such as an air stream condition in some cases. Therefore, a conventional guide vane method can be selected depending on a classification purpose.

Since in the pneumatic classifier 10, the outer periphery of the classifying chamber 18 of substantially disc shape in the circumferential direction is closed by the annular wall 19 of annular shape, even when a large flow volume of pressurized gas is forcibly flown from the first air nozzles 34 and the second air nozzles 36, air is not leaked outward in the circumferential direction of the classifying chamber 18, and a swirl is not disturbed. Therefore, in particular, by increasing an inflow amount of pressurized gas from the first air nozzles 34 configured to form a whirling stream in the coarse powder collecting chamber 28, sub-micron particles can be stably classified.

While fine particles such as sub-micron particles have a property of being apt to be mutually agglomerated; however, in the pneumatic classifier 10, since a large flow volume of pressurized gas is ejected from the first air nozzles 34 and the second air nozzles 36, the particles can be efficiently classified. In addition, as the feed powder, various kinds of powder from powder of low specific gravity such as silica or toner to powder of high specific gravity such as metal or alumina can be used as an object to be classified.

However, according to a classification purpose, the second air nozzle 36 may be configured in a guide vane method in which a setting range of air volume is wide.

### (Second Example of Pneumatic Classifier)

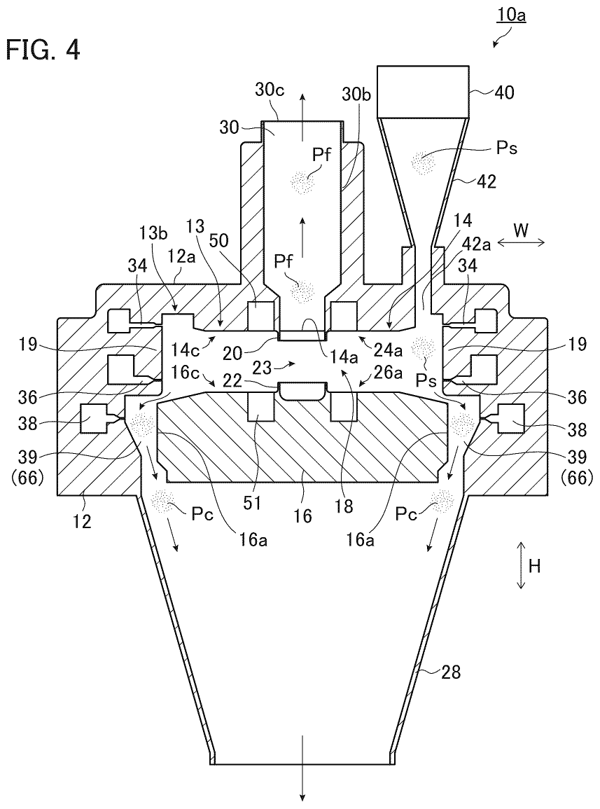

FIG. 4 is a schematic cross-sectional view showing a second example of the pneumatic classifier in the embodiment of the invention.

For a pneumatic classifier 10a shown in FIG. 4, constituent elements identical to those of the pneumatic classifier 10 shown in FIG. 1 are assigned the same reference signs and will not be described in detail.

The pneumatic classifier 10a shown in FIG. 4 is different from the pneumatic classifier 10 shown in FIG. 1 in that a first cylindrical portion 20 of cylindrical shape and a second cylindrical portion 22 of cylindrical shape are provided, and otherwise has the same configuration as the pneumatic classifier 10 shown in FIG. 1.

In the pneumatic classifier 10a, the upper disc-shaped portion 14 is provided with the first cylindrical portion 20 projecting in the classifying chamber 18 along the edge of the fine powder discharging port 14a. The first cylindrical portion 20 is constituted of, for example, a cylindrical member having the same inner diameter as that of the fine powder discharging port 14a. The first cylindrical portion 20 communicates with the fine powder discharging port 14a. The second cylindrical portion 22 of cylindrical shape is disposed on the classifying plate 16, which is the other of the members, to face the first cylindrical portion 20 at a predetermined distance such that a gap 23 is formed therebetween. The first cylindrical portion 20 and the second cylindrical portion 22 are situated in the central portion of the classifying chamber 18 in the direction W.

In the pneumatic classifier 10a, as with the pneumatic classifier 10 described above, when feed powder having a particle size distribution is classified into fine powder and coarse powder, the classification point can be smaller than that in a conventional one while high accuracy is maintained. Further, the first cylindrical portion 20 and the second cylindrical portion 22 suppress flowing of the coarse powder Pc having a large particle size into the fine powder collecting pipe 30 and allow the coarse powder Pc having a large particle size to remain in the classifying chamber 18. On the other hand, the fine powder Pf having a size of the classification point or less, together with an air stream, can pass the gap 23 and be sucked into the fine powder collecting pipe 30 via the fine particle discharging port 14a. The collected powder Pf can have a smaller particle size.

Provision of the first cylindrical portion 20 and the second cylindrical portion 22 allows the classification point to be smaller than that in a conventional one.

### (Third Example of Pneumatic Classifier)

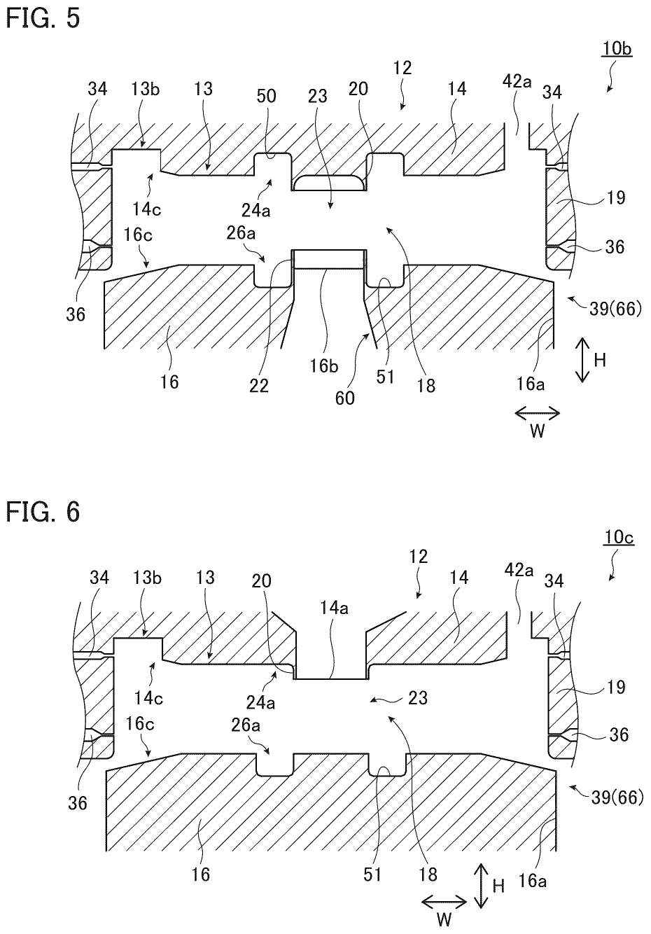

FIG. 5 is a schematic partial cross-sectional view showing a third example of the pneumatic classifier in the embodiment of the invention.

For a pneumatic classifier 10b shown in FIG. 5, constituent elements identical to those of the pneumatic classifier 10a shown in FIG. 4 are assigned the same reference signs and will not be described in detail.

The pneumatic classifier 10b shown in FIG. 5 is different from the pneumatic classifier 10a shown in FIG. 4 in that the classifying plate 16 is provided with a fine powder discharging port 16b and the fine powder Pf is taken out through the classifying plate 16, and otherwise has the same configuration as the pneumatic classifier 10a shown in FIG. 4.

The pneumatic classifier 10b is provided with the groove portion 51 in the second region 26a around the fine powder discharging port 16b. The groove portion 50 is provided in the first region 24a of the upper disc-shaped portion 14 to face the groove portion 51. In the pneumatic classifier 10b, the first region 24a of the upper disc-shaped portion 14 is a region facing the periphery of the fine powder discharging port 16b. The groove portion 51 is not limited to being provided along the outer edge of the fine powder discharging port 16b as long as the position where the groove portion 51 is provided is within the second region 26a around the fine powder discharging port 16b.

The fine powder discharging port 16b is provided with a fine powder collecting pipe 60. As with the fine powder collecting pipe 30 (see FIG. 4), an end (not shown) of the fine powder collecting pipe 60 is joined to a suction blower (not shown) via, for example, a bag filter (not shown) and other components. The bag filter (not shown), the suction blower (not shown) and other components constitute a fine powder collecting device. The fine powder collecting pipe 60 constitutes a fine powder collecting section. The fine powder Pf is collected via the fine powder collecting pipe 60. The pneumatic classifier 10b also can provide the same effects as those obtained with pneumatic classifier 10a shown in FIG. 4.

In the configuration of the coarse powder collecting section shown in FIG. 5, the fine powder Pf (see FIG. 1) is discharged from the side of the classifying plate 16, while the coarse powder Pc (see FIG. 1) is discharged from the side of the classifying plate 16 and also the gap 39 (the coarse powder discharging port 66) between the outer end portion 16a of the classifying plate 16 and the annular wall 19 of the casing 12 (see FIG. 1).

As with the pneumatic classifiers 10 and 10a shown FIGS. 1 and 4, the configuration in which the fine powder Pf is taken out through the upper disc-like portion 14 may be employed, or as described for the pneumatic classifier 10b, the configuration in which the fine powder Pf is taken out through the classification plate 16 may be employed. In the pneumatic classifier, how to take out the fine powder Pf is not particularly limited.

### (Fourth Example of Pneumatic Classifier)

FIG. 6 is a schematic partial cross-sectional view showing a fourth example of the pneumatic classifier in the embodiment of the invention.

For a pneumatic classifier 10c shown in FIG. 6, constituent elements identical to those of the pneumatic classifier 10 shown in FIG. 1 are assigned the same reference signs and will not be described in detail.

The pneumatic classifier 10c shown in FIG. 6 is different from the pneumatic classifier 10 shown in FIG. 1 in that the cylindrical portion 20 is provided at the upper disc-shaped portion 14 and the groove portion 51 is provided in the classifying plate 16, and otherwise has the same configuration as the pneumatic classifier 10 shown in FIG. 1.

In the pneumatic classifier 10c, the upper disc-shaped portion 14 is provided with the first cylindrical portion 20 projecting in the classifying chamber 18 along the edge of the fine powder discharging port 14a.

The groove portion 51 is provided in the second region 26a of the classifying plate 16 that faces the first region 24a around the fine powder discharging port 14a. In the pneumatic classifier 10b, the first region 24a of the upper disc-shaped portion 14 is a region facing the periphery of the fine powder discharging port 16b. The second cylindrical portion 22 is not provided in the classifying plate 16. The pneumatic classifier 10c has a configuration in which the first cylindrical portion 20 is provided at the upper disc-shaped portion 14 (one of the members) and the groove portion 51 is provided in the classifying plate 16 (the other of the members).

The pneumatic classifier 10c also can provide the same effects as those obtained with the pneumatic classifier 10 shown in FIG. 1.

The groove portion 51 can suppress adhesion of powder to the inside of the classifying chamber 18, and the powder can be stably classified for a long period of time, whereby the classification accuracy can be maintained for a long period of time.

In addition, the first cylindrical portion 20 suppresses flowing of the coarse powder Pc having a large particle size (see FIG. 1) into the fine powder collecting pipe 30 (see FIG. 1), and the collected fine powder Pf (see FIG. 1) can have a smaller particle size.

### (Fifth Example of Pneumatic Classifier)

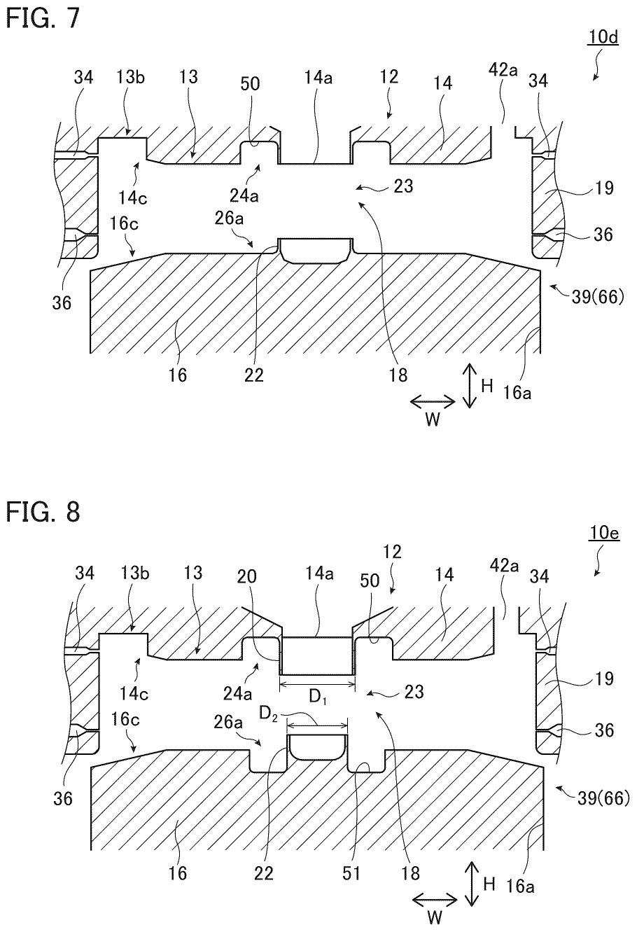

FIG. 7 is a schematic partial cross-sectional view showing a fifth example of the pneumatic classifier in the embodiment of the invention.

For a pneumatic classifier 10d shown in FIG. 7, constituent elements identical to those of the pneumatic classifier 10a shown in FIG. 4 are assigned the same reference signs and will not be described in detail.

The pneumatic classifier 10d shown in FIG. 7 is different from the pneumatic classifier 10a shown in FIG. 4 in that the first cylindrical portion 20 is not provided and the groove portion 51 is not provided in the classifying plate 16, and otherwise has the same configuration as the pneumatic classifier 10a shown in FIG. 4.

The pneumatic classifier 10d has a configuration in which the second cylindrical portion 22 is provided in the classifying plate 16 (the other of the members) and the groove portion 50 is provided in the upper disc-shaped portion 14 (one of the members).

The pneumatic classifier 10d can also provide the same effects as those obtained with the pneumatic classifier 10 shown in FIG. 1. Further, the groove portion 50 can suppress adhesion of powder to the inside of the classifying chamber 18, and the powder can be stably classified for a long period of time, whereby the classification accuracy can be maintained for a long period of time.

In addition, the second cylindrical portion 22 suppresses flowing of the coarse powder Pc having a large particle diameter into the fine powder collecting pipe 30 (see FIG. 1), and the collected fine powder Pf can have a smaller particle size.

(Sixth Example of pneumatic Classifier)

FIG. 8 is a schematic partial cross-sectional view showing a sixth example of the pneumatic classifier in the embodiment of the invention.

For a pneumatic classifier 10e shown in FIG. 8, constituent elements identical to those of the pneumatic classifier 10a shown in FIG. 4 are assigned the same reference signs and will not be described in detail.

The pneumatic classifier 10e shown in FIG. 8 is different from the pneumatic classifier 10a shown in FIG. 4 in a diameter D₁ of the first cylindrical portion 20 and a diameter D₂ of the second cylindrical portion 22, and otherwise has the same configuration as the pneumatic classifier 10a shown in FIG. 4. In the pneumatic classifier 10e, the diameter D₁ of the first cylindrical portion 20 is larger than the diameter D₂ of the second cylindrical portion 22.

The pneumatic classifier 10e also can provide the same effects as those obtained with pneumatic classifier 10a shown in FIG. 4.

### (Seventh Example of Pneumatic Classifier)

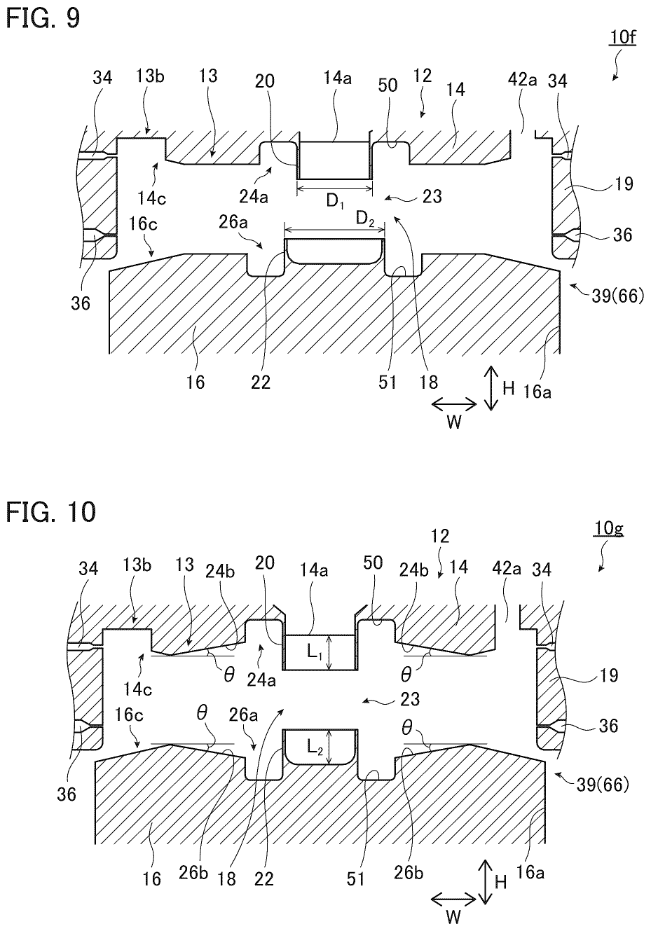

FIG. 9 is a schematic partial cross-sectional view showing a seventh example of the pneumatic classifier in the embodiment of the invention.

For a pneumatic classifier 10f shown in FIG. 9, constituent elements identical to those of the pneumatic classifier 10a shown in FIG. 4 are assigned the same reference signs and will not be described in detail.

The pneumatic classifier 10f shown in FIG. 9 is different from the pneumatic classifier 10a shown in FIG. 4 in a diameter D₁ of the first cylindrical portion 20 and a diameter D₂ of the second cylindrical portion 22, and otherwise has the same configuration as the pneumatic classifier 10a shown in FIG. 4. In the pneumatic classifier 10f shown in FIG. 9, the diameter D₂ of the second cylindrical portion 22 is larger than the diameter D₁ of the first cylindrical portion 20.

The pneumatic classifier 10e also can provide the same effects as those obtained with pneumatic classifier 10a shown in FIG. 4.

### (Eighth Example of Pneumatic Classifier)

FIG. 10 is a schematic partial cross-sectional view showing an eighth example of the pneumatic classifier in the embodiment of the invention.

For a pneumatic classifier 10g shown in FIG. 10, constituent elements identical to those of the pneumatic classifier 10a shown in FIG. 4 are assigned the same reference signs and will not be described in detail.

The pneumatic classifier 10g shown in FIG. 10 is different from the pneumatic classifier 10a shown in FIG. 4 in that an inclined portion 24b is formed in the first region 24a of the upper disc-shaped portion 14 and an inclined portion 26b is formed in the second region 26a of the classifying plate 16, and otherwise has the same configuration as the pneumatic classifier 10a shown in FIG. 4.

In the pneumatic classifier 10g shown in FIG. 10, the surface 14c of the upper disc-shaped portion 14 that faces the classifying chamber 18 is provided with the inclined portion 24b on the side closer to the first cylindrical portion 20 of cylindrical shape. The inclined portion 24b is provided with the groove portion 50.

The surface 16c of the classifying plate 16 that faces the classifying chamber 18 is provided with the inclined portion 26b on the side closer to the second cylindrical portion 22 of cylindrical shape. The inclined portion 26b is provided with the groove portion 51.

The inclined portion 24b and the inclined portion 26b are inclined surfaces constituted of flat surfaces and have linear cross sections. The inclined portion 24b and the inclined portion 26b are inclined such that the height of the classifying chamber 18 is gradually increased from the annular wall 19 toward the fine powder discharging port 14a. In other words, the inclined portion 24b of the upper disc-shaped portion 14 ascends toward the fine powder discharging port 14a. The inclined portion 26b of the classifying plate 16 descends toward the second cylindrical portion 22.

Provision of the inclined portion 24b and the inclined portion 26b allows a length L₁ of the first cylindrical portion 20 and a length L₂ of the second cylindrical portion 22 to be increased, and the collected fine powder Pf (see FIG. 1) can have a smaller particle size.

The angle of the inclined portion 24b of the upper disc-shaped portion 14 and the angle of the inclined portion 26b of the classifying plate 16 with respect to a line parallel to the direction W are each represented by θ. The angle θ is preferably 5° to 30° and more preferably 10° to 20°. With an angle θ of about 5° to about 30°, the classification point can be smaller in the classification of the feed powder Ps into the fine powder Pf and the coarse powder Pc.

The angle θ of the inclined portion 24b of the upper disc-shaped portion 14 and the angle θ of the inclined portion 26b of the classifying plate 16 may be the same or different.

The surface 14c of the upper disc-shaped portion 14 may be constituted of an inclined surface extending from the periphery to the outer edge of the first cylindrical portion 20. In other words, the surface 14c of the upper disc-shaped portion 14 may be constituted of an inclined surface. The surface 16c of the classifying plate 16 may be constituted of an inclined surface reaching from the peripheral edge to the outer edge of the second cylindrical portion 22. In other words, the surface 16c of the classifying plate 16 may be constituted of an inclined surface.

While the inclined portion 24b and the inclined portion 26b have linear cross sections as described above, their cross sections are not necessarily required to be linear, and the inclined portion 24b and the inclined portion 26b may be constituted of curved surfaces such that the height of the classifying chamber 18 is increased from the outer side toward the center thereof, i.e., the central height of the classifying chamber 18 is the highest, and may have curved cross sections. Further, the inclined portion 24b and the inclined portion 26b may be constituted of a combination of a flat surface and a curved surface, and in this case, their cross sections are the combination of a linear cross section and a curved cross section.

While the pneumatic classifier 10g has the configuration in which the first cylindrical portion 20 and the second cylindrical portion 22 are provided, the invention is not limited thereto, and it suffices if at least one of the first cylindrical portion 20 and the second cylindrical portion 22 is provided.

In the pneumatic classifier 10g, also for the inclined portion 24b and the inclined portion 26b, it suffices if at least one of them is provided.

In addition, in the pneumatic classifier 10g, also for the groove portion 50 and the groove portion 51, it suffices if at least one of them is provided.

### (Ninth Example of Pneumatic Classifier)

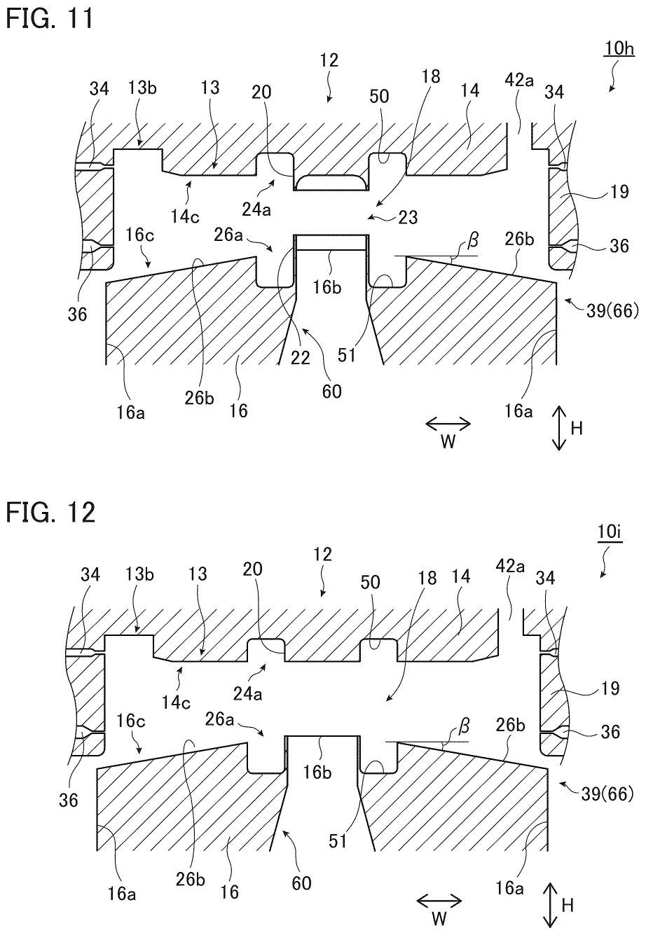

FIG. 11 is a schematic partial cross-sectional view showing a ninth example of the pneumatic classifier in the embodiment of the invention.

For a pneumatic classifier 10h shown in FIG. 11, constituent elements identical to those of the pneumatic classifier 10b shown in FIG. 5 are assigned the same reference signs and will not be described in detail.

The pneumatic classifier 10h shown in FIG. 11 is different from the pneumatic classifier 10b shown in FIG. 5 in that the inclined portion 26b is formed in the second region 26a of the classifying plate 16, and otherwise has the same configuration as the pneumatic classifier 10b shown in FIG. 5.

In the pneumatic classifier 10h shown in FIG. 11, the surface 16c of the classifying plate 16 that faces the classifying chamber 18 is formed by the inclined portion 26b. The inclined portion 26b is an inclined surface constituted of a flat surface and has a linear cross section. The inclined portion 26b is inclined such that the height of the classifying chamber 18 is decreased from the annular wall 19 toward the fine particle discharging port 16b, i.e., from the outer side to the center of the classifying chamber 18. In other words, the surface 16c of the classifying plate 16 declines toward the outer end portion 16a. The groove portion 51 is provided in the inclined portion 26b, i.e., the inclined surface.

The angle of the inclined portion 26b of the classifying plate 16 with respect to a line parallel to the direction W of the upper disc-shaped portion 14 is represented by β. The angle β is preferably 5° to 30° and more preferably 10° to 20°.

The pneumatic classifier 10h also can provide the same effects as those obtained with the pneumatic classifier 10b shown in FIG. 5.

While in the pneumatic classifier 10h, the inclined portion 26b is provided in the surface 16c of the classifying plate 16, the invention is not limited thereto, and the inclined surface 24b (see FIG. 10) may be provided in the surface 14c of the upper disc-shaped portion 14. In addition, it suffices if at least one of the inclined portion 24b and the inclined portion 26b is provided.

While the pneumatic classifier 10h has the configuration in which the first cylindrical portion 20 and the second cylindrical portion 22 are provided, the invention is not limited thereto, and it suffices if at least one of the first cylindrical portion 20 and the second cylindrical portion 22 is provided.

In the configuration of a coarse powder collecting section shown in FIG. 11, the fine powder Pf (not shown) is discharged from the side of the classifying plate 16, while the coarse powder Pc (not shown) is discharged from the side of the classifying plate 16 and also the gap 39 (the coarse powder discharging port 66) between the outer end portion 16a of the classifying plate 16 and the annular wall 19 of the casing 12 (see FIG. 1).

### (Tenth Example of Pneumatic Classifier)

FIG. 12 is a schematic partial cross-sectional view showing a tenth example of the pneumatic classifier in the embodiment of the invention. For a pneumatic classifier 10i shown in FIG. 12, constituent elements identical to those of the pneumatic classifier 10h shown in FIG. 11 are assigned the same reference signs and will not be described in detail.

The pneumatic classifier 10i shown in FIG. 12 is different from the pneumatic classifier 10h shown in FIG. 11 in that the first cylindrical portion 20 is not provided, and otherwise has the same configuration as the pneumatic classifier 10h shown in FIG. 11.

In the configuration of a coarse powder collecting section shown in FIG. 12, the fine powder Pf (not shown) is discharged from the side of the classifying plate 16, while the coarse powder Pc (not shown) is discharged from the side of the classifying plate 16 and also the gap 39 (the coarse powder discharging port 66) between the outer end portion 16a of the classifying plate 16 and the annular wall 19 of the casing 12 (see FIG. 1).

The pneumatic classifier 10h also can provide the same effects as those obtained with the pneumatic classifier 10 shown in FIG. 1.

### (Eleventh Example of Pneumatic Classifier)

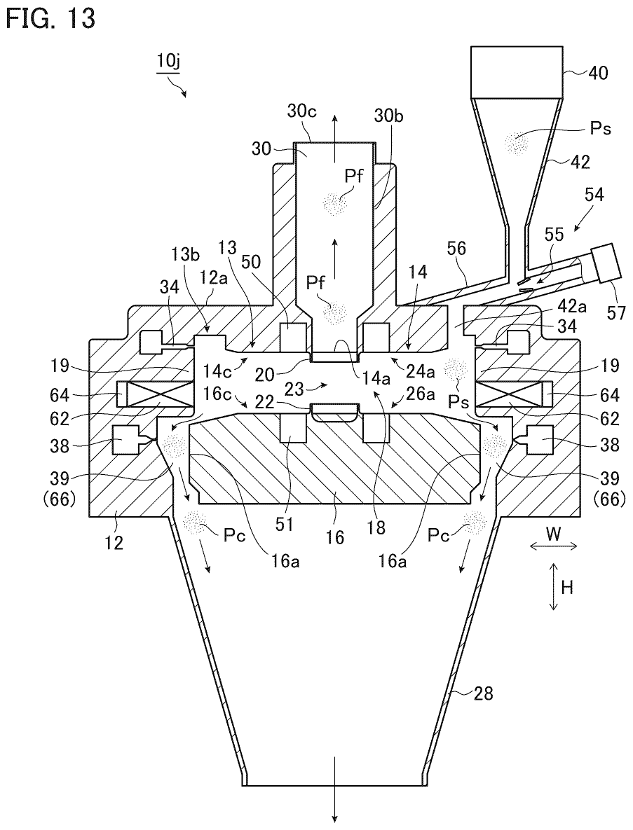

FIG. 13 is a schematic cross-sectional view showing an eleventh example of the pneumatic classifier in the embodiment of the invention.

For a pneumatic classifier 10j shown in FIG. 13, constituent elements identical to those of the pneumatic classifier 10 shown in FIG. 1 are assigned the same reference signs and will not be described in detail.

The pneumatic classifier 10j shown in FIG. 13 is different from the pneumatic classifier 10 shown in FIG. 1 in that an ejector portion 54 is provided to the feed powder supply section 40 and guide vanes 62 are disposed in place of the second air nozzles 36, and otherwise has the same configuration as the pneumatic classifier 10 shown in FIG. 1.

In the pneumatic classifier 10j shown in FIG. 13, the ejector portion 54 is provided to the supply pipe 42 of the feed powder supply section 40. The ejector portion 54 includes an ejection nozzle 55 that ejects the feed powder Ps to the classifying chamber 18, and a pressure portion 57 that supplies, for example, air to the ejection nozzle 55 with high pressure. The ejection nozzle 55 is connected to, for example, the upper disc-shaped portion 14 by means of a pipe 56. Using high-pressure air supplied from the pressure portion 57 via the ejection nozzle 55 and the pipe 56, the feed powder Ps in the feed powder supply section 40 passes through the opening portion 42a of the upper disc-shaped portion 14 and is supplied to the classifying chamber 18.

In the pneumatic classifier 10j, with the ejector portion 54, the feed powder Ps can be reliably supplied to a swirling stream generated in the classifying chamber 18. As the ejection nozzle 55 and the pressure portion 57 of the ejector portion 54, known devices used in transport of powder can be appropriately used.

In addition, in the pneumatic classifier 10j shown in FIG. 13, as with the second air nozzles 36 in the pneumatic classifier 10 shown in FIG. 1, the plurality of guide vanes 62 are disposed along the outer edge of the classifying chamber 18. The guide vanes 62 are disposed in the annular wall 19 under the first air nozzles 34 in the H direction. As with the first air nozzles 34, the guide vanes 62 are arranged at regular intervals in the circumferential direction of the classifying chamber 18 at a predetermined angle to a tangential direction of the outer edge of the classifying chamber 18. The gas supply section includes the first air nozzles 34 and the guide vanes 62. The gas supply section may not have the first air nozzle 34 but have the guide vanes 62.

A push-in chamber 64 used to store air and supply gas into the classifying chamber 18 is disposed at the outer peripheral portion of the guide vanes 62. The push-in chamber 64 is connected to a pressurized gas supply section (not shown). Gas under a predetermined pressure, i.e., pressurized gas is supplied from the pressurized gas supply section and introduced from between the guide vanes 62 via the push-in chamber 64. Pressurized gas is supplied separately to the first air nozzles 34 and the guide vanes 62, so that whirling streams are generated in the classifying chamber 18.

In the pneumatic classifier 10j, the feed powder Ps is centrifuged while it falls as whirling in the classifying chamber 18, and the guide vanes 62 act to regulate the whirling speed of the feed powder Ps during the centrifugation. Each guide vane 62 is, for instance, pivotally supported by a pivot shaft (not shown) in the annular wall 19 and locked to a pivotal plate (not shown) by means of a pin (not shown). For example, when the pivotal plate is rotated, all the guide vanes 62 are thereby simultaneously rotated by a predetermined angle. By rotating the pivotal plate to rotate all the guide vanes 62 by a predetermined angle, the intervals between the guide vanes 62 can be adjusted to change the flow rate of gas, e.g., air passing through the guide vanes 62. Thus, the classification performance such as a classification point can be changed. Further, the provision of the guide vanes 62 expands a range of choices of the classification point. The pneumatic classifier 10j shown in FIG. 13 also can provide the same effects as those obtained with the pneumatic classifier 10 shown in FIG. 1.

While the pneumatic classifier 10j has the ejector portion 54, each of the above-mentioned pneumatic classifiers 10 and 10a to 10i may have the ejector portion 54.

In addition, while the feed powder supply section 40 is connected to the upper disc-shaped portion 14 and is configured such that the feed powder Ps passes through the opening portion 42a of the upper disc-shaped portion 14 and is supplied to the whirling stream generated in the classifying chamber 18, the invention is not limited thereto. For example, the feed powder supply section 40 may be connected to the classifying plate 16 to supply the feed powder Ps to the whirling stream generated in the classifying chamber 18.

While in the pneumatic classifier 10j, the guide vanes 62 are disposed in place of the second air nozzles 36 of the pneumatic classifier 10 shown in FIG. 1, the invention is not limited thereto. The guide vanes 62 may be disposed in place of the second air nozzles 36 in any of the pneumatic classifiers of the second to eleventh examples of the above-mentioned pneumatic classifier.

The present invention is basically configured as above. While the pneumatic classifier of the invention is described above in detail, the invention is by no means limited to the foregoing embodiment and it should be understood that various improvements and modifications are possible without departing from the scope and spirit of the invention.

### EXAMPLES

The classification using the pneumatic classifier of the invention is described below more specifically.

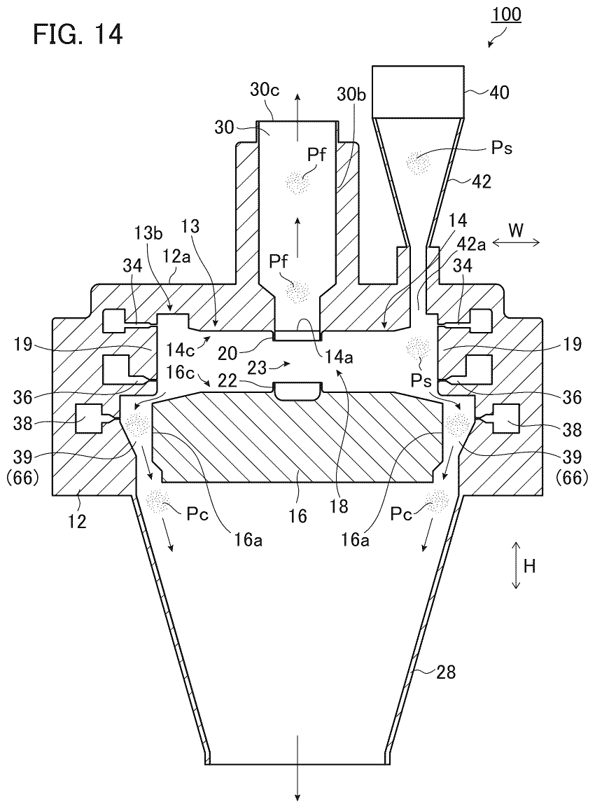

Feed powder is classified using the foregoing pneumatic classifier 10a shown in FIG. 4 and a first pneumatic classifier 100 for comparison shown in FIG. 14.

FIG. 14 is a schematic cross-sectional view showing the first pneumatic classifier for comparison. For the pneumatic classifier 100 shown in FIG. 14, constituent elements identical to those of the pneumatic classifier 10a shown in FIG. 4 are assigned the same reference signs and will not be described in detail.

The first pneumatic classifier 100 shown in FIG. 14 has the same configuration as the pneumatic classifier 10a shown in FIG. 4 except that the groove portion 50 and the groove portion 51 are not provided.

The classification was carried out under classification conditions such as air volume being the same between the pneumatic classifier 10a of the invention and the first pneumatic classifier 100 for comparison.

As the feed powder, ceramic particles having an average particle size of 0.4 μm were used. The value of the average particle size is obtained by measurements using the laser diffraction-scattering technique.

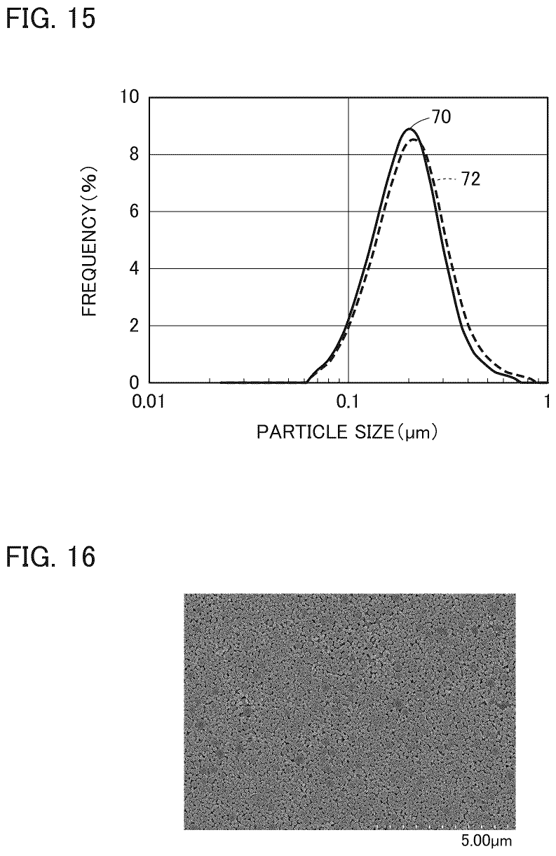

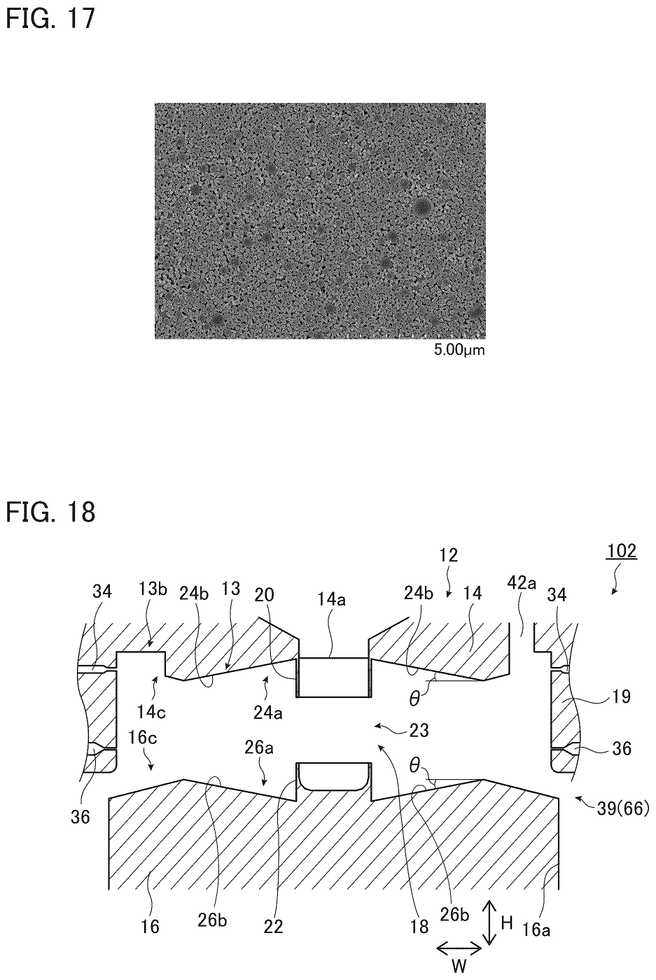

The classification result is shown in a graph of FIG. 15. In addition, FIG. 16 shows ceramic particles after classification by means of the pneumatic classifier 10a. FIG. 17 shows ceramic particles after classification by means of the first pneumatic classifier 100. FIGS. 16 and 17 are scanning electron microscope (SEM) images with a magnification of 10000 times.

In FIG. 15, the numeral 70 shows the result of the classification by means of the pneumatic classifier 10a shown in FIG. 4, while the numeral 72 shows the result of the classification by means of the first pneumatic classifier 100 shown in FIG. 14. As shown in FIG. 15, the classification accuracy is high, and it is possible to achieve a smaller classification point in the present invention. As shown in FIGS. 16 and 17, more coarse particles were observed after the classification in the first pneumatic classifier 100 than in the pneumatic classifier 10a. It was confirmed that much powder was adhered to the first cylindrical portion 20 in the first pneumatic classifier 100 for comparison than in the pneumatic classifier 10a.

FIG. 18 is a schematic partial cross-sectional view showing a second pneumatic classifier for comparison. For a second pneumatic classifier 102 shown in FIG. 18, constituent elements identical to those of the second pneumatic classifier 10g shown in FIG. 10 are assigned the same reference signs and will not be described in detail. The second pneumatic classifier 102 shown in FIG. 18 has the same configuration as the pneumatic classifier 10g shown in FIG. 10 except that the groove portions 50 and 51 are not provided.

The classification was carried out under classification conditions such as air volume being the same between the pneumatic classifier 10g of the present invention and the second pneumatic classifier 102 for comparison.

As the feed powder, ceramic particles having an average particle size of 0.4 μm were used. The value of the average particle size is obtained by measurements using the laser diffraction-scattering technique.

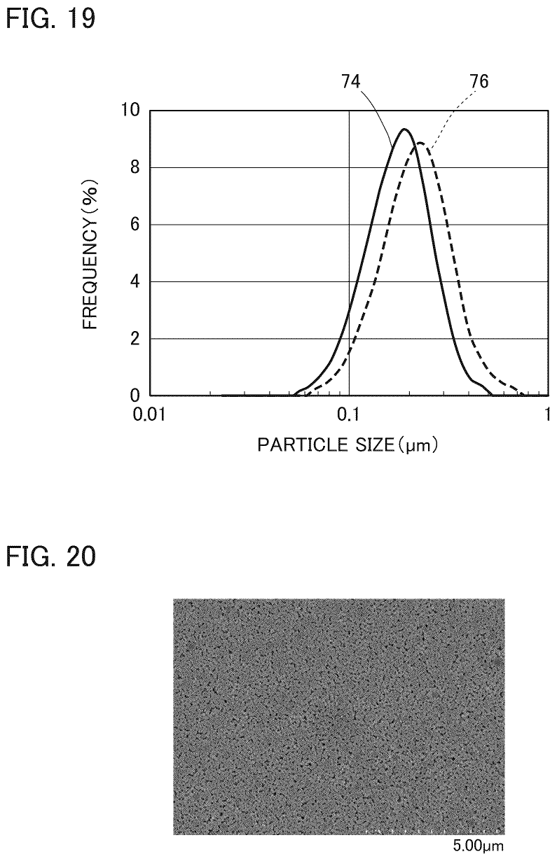

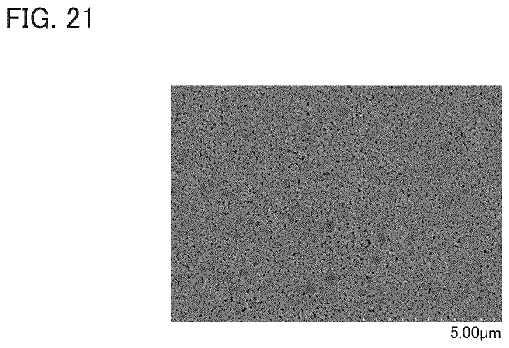

The classification result is shown in a graph of FIG. 19. In addition, FIG. 20 shows ceramic particles after classification by means of the pneumatic classifier 10g. FIG. 21 shows ceramic particles after classification by means of the second pneumatic classifier 102. FIGS. 20 and 21 are SEM images with a magnification of 10000 times.

In FIG. 19, the numeral 74 shows the result of the classification by means of the pneumatic classifier 10g shown in FIG. 10, while the numeral 76 shows the result of the classification by means of the second pneumatic classifier 102 shown in FIG. 18. As shown in FIG. 19, the classification accuracy is high, and it is possible to achieve a smaller classification point in the present invention. As shown in FIGS. 20 and 21, more coarse particles were observed after the classification in the second pneumatic classifier 102 than in the pneumatic classifier 10g. It was confirmed that much powder was adhered to the first cylindrical portion 20 in the second pneumatic classifier 102 for comparison than in the pneumatic classifier 10g.

### REFERENCE SIGNS LIST

10, 10a, 10b, 10c, 10d, 10e, 10f, 10g pneumatic classifier
10h, 10i, 10j pneumatic classifier
12 casing
12a surface
13 ceiling wall
13b outer edge
14 upper disc-shaped portion
14a, 16b fine powder discharging port
16 classifying plate
16a outer end portion
18 classifying chamber
19 annular wall
20 first cylindrical portion
22 second cylindrical portion
23 gap
24a first region
24b inclined portion
26a second region
26b inclined portion
28 coarse powder collecting chamber
30 fine powder collecting pipe
30c end
34 first air nozzle
36 second air nozzle
38 third air nozzle
39 gap
40 feed powder supply section
42 supply pipe
50, 51, 52 groove portion
54 ejector portion
55 ejection nozzle
56 pipe
60 fine powder collecting pipe
62 guide vane
64 push-in chamber
66 coarse powder discharging port
100 first pneumatic classifier
102 second pneumatic classifier
H direction
Pc coarse powder
Pf fine powder
Ps feed powder
W direction
β, θ angle

1. A pneumatic classifier comprising: a casing having a ceiling wall and an annular wall provided continuously to an outer edge of the ceiling wall;
a classifying plate disposed such that a surface of the classifying plate faces the ceiling wall of the casing;
a classifying chamber constituted between the ceiling wall of the casing and the surface of the classifying plate;
a gas supply section configured to supply gas into the classifying chamber to generate a whirling stream;
a feed powder supply section configured to supply feed powder to the whirling stream generated in the classifying chamber;
a fine powder discharging port provided at a central part of one of the ceiling wall of the casing and the surface of the classifying plate that constitute the classifying chamber;
a coarse powder discharging port opening along an outer periphery of the classifying chamber on a side of either the ceiling wall or the surface of the classifying chamber that faces the ceiling wall; and
a groove portion provided in at least one of the ceiling wall or the surface of the classifying plate.

2. The pneumatic classifier according to claim 1, comprising at least one of a first cylindrical portion provided at the fine powder discharging port or a second cylindrical portion provided in the surface of the classifying plate of the classifying chamber to face the first cylindrical portion at a predetermined distance.

3. The pneumatic classifier according to claim 2, wherein a diameter of the first cylindrical portion is different from that of the second cylindrical portion.

4. The pneumatic classifier according to claim 1, wherein an inclined surface is formed in at least one of the ceiling wall of the casing or the surface of the classifying plate, and
the groove portion is provided in the inclined surface.

5. The pneumatic classifier according to claim 2, wherein an inclined surface is formed in at least one of a peripheral edge of the first cylindrical portion of the ceiling wall of the casing or a peripheral edge of the second cylindrical portion of the surface of the classifying plate, and
the groove portion is provided in the inclined surface.

6. The pneumatic classifier according to claim 1, wherein the fine powder discharging port has a circular shape, and the groove portion is arranged concentrically with the fine powder discharging port.

7. The pneumatic classifier according to claim 1, wherein the groove portion is provided in each of the ceiling wall and the surface of the classifying plate.

8. The pneumatic classifier according to claim 7, wherein the fine powder discharging port has a circular shape, the groove portion is arranged concentrically with the fine powder discharging port, and the groove portion provided in the ceiling wall faces the groove portion provided in the surface of the classifying plate.

9. The pneumatic classifier according to claim 7, wherein in one of the ceiling wall and the surface of the classifying plate, the one having the fine powder discharging port, the groove portion is provided concentrically with the fine powder discharging port along a periphery of the fine powder discharging port, and in another of the ceiling wall and the surface of the classifying plate, the another having no fine powder discharging port, a groove portion of concentric circle shape is provided to face the groove portion of the concentric circle shape provided in a region around the fine powder discharging port, and
the groove portion of the concentric circle shape provided in the one having the fine powder discharging port and the groove portion of the concentric circle shape provided in the another having no fine powder discharging port are disposed at a same position in a direction perpendicular to a direction in which the ceiling wall of the casing of the classifying chamber and the surface of the classifying plate face each other.

10. The pneumatic classifier according to claim 1, wherein a plurality of the groove portions are provided along a periphery of the fine powder discharging port.

11. The pneumatic classifier according to claim 2, wherein the first cylindrical portion is provided in the ceiling wall, and the groove portion is provided in the surface of the classifying plate.

12. The pneumatic classifier according to claim 2, wherein the second cylindrical portion is provided in the surface of the classifying plate, and the groove portion is provided in the ceiling wall.

13. The pneumatic classifier according to claim 4, wherein the inclined surface is inclined such that a height of the classifying chamber is gradually increased from an outer side to a center of the classifying chamber.

14. The pneumatic classifier according to claim 4, wherein the inclined surface is inclined such that a height of the classifying chamber is decreased from an outer side to a center of the classifying chamber.

15. The pneumatic classifier according to claim 1, wherein the feed powder supply section is connected to one of the ceiling wall of the casing and the surface of the classifying plate that constitute the classifying chamber and supplies the feed powder to the swirling stream generated in the classifying chamber.

16. The pneumatic classifier according to claim 1, wherein the feed powder supply section includes an ejection nozzle that supplies the feed powder to the swirling stream generated in the classifying chamber.

17. The pneumatic classifier according to claim 1, wherein the gas supply section includes a plurality of air nozzles, and the plurality of air nozzles are arranged at regular intervals in a circumferential direction of the classifying chamber along an outer edge of the classifying chamber.

18. The pneumatic classifier according to claim 1, wherein the gas supply section includes a plurality of guide vanes, and the plurality of guide vanes are arranged at regular intervals in a circumferential direction of the classifying chamber along an outer edge of the classifying chamber.

19. The pneumatic classifier according to claim 5, wherein the inclined surface is inclined such that a height of the classifying chamber is gradually increased from an outer side to a center of the classifying chamber.

20. The pneumatic classifier according to claim 5, wherein the inclined surface is inclined such that a height of the classifying chamber is decreased from an outer side to a center of the classifying chamber.
